(19) United States
(12) Patent Application Publication
(10) Pub. No.: US 2005/0179359 A1
(43) Pub. Date: Aug. 18, 2005

(54) CAVITY STRUCTURE AND COLD CATHODE FLUORESCENT FLAT LAMP USING THE SAME

(76) Inventors: Yui-Shin Fran, Hsinchu (TW); Jer-Shien Yang, Chia-Yi Hsien (TW); Lai-Cheng Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,282

(22) Filed: Sep. 7, 2004

(30) Foreign Application Priority Data
Feb. 12, 2004 (TW) 93103278

(51) Int. Cl. H01J 1/62; H01J 63/04

(52) U.S. Cl. 313/495; 313/493

(57) ABSTRACT

A cavity structure and a cold cathode fluorescent flat lamp using the same are provided. The cold cathode fluorescent flat lamp (CCFFL) comprises a cavity structure, at least and electrode set, a fluorescent substance and a discharge gas. The cavity structure comprises a cavity shell, a plurality of spacer and a hardening paste. The spacers are disposed in the cavity shell. The tolerance of the height of the spacers is larger than about 0.01 mm, or between about 1/20 to about ¼ of the height of the spacer. The hardening paste is disposed between the spacer and the cavity shell. The electrode set is disposed inside the cavity shell or outside the cavity shell. The fluorescent substance is disposed on the inner wall of the cavity shell. The discharge gas is filled inside the cavity shell.

### CROSS REFERENCE TO RELATED APPLICATIONS

This application claims the priority benefit of Taiwan application serial no. 93103278, filed Feb. 12, 2004.

### BACKGROUND OF INVENTION

1. Field of the Invention

The present invention generally relates to a cavity structure and a cold cathode fluorescent flat lamp (CCFFL) using the same. More particularly, the present invention relates to a cavity structure having spacers with tolerance of height larger than about 0.01 mm and cold cathode fluorescent flat lamp (CCFFL) using the same.

2. Description of Related Art

In recently years, the portable electronic device such as the mobile phone, digital camera, digital video camera, notebook or the personal computer has been developed drastically since the development of semiconductor process and the display component. It is noted that, for all the electronic device described above, the display device is a necessary and important device for data input/output of the user. Recently, a variety of display devices are composed by the liquid crystal display (LCD) panel. Since the LCD panel is not self-illuminant, a backlight module is required to be disposed under the LCD panel as a light source.

In general, since the cold cathode fluorescent flat lamp (CCFFL) has excellent luminous efficiency and uniformity, and may be used as a light source for large area, the cold cathode fluorescent flat lamp (CCFFL) has been widely used as the backlight of a LCD panel. The cold cathode fluorescent flat lamp (CCFFL) is a plasma lighting component, and the principle of lighting is described in the following. First of all, a high voltage is applied via the electrodes to generate high energy electrons. The inert gas between the cathode and the anode of the gas discharge cavity is collided and excited by the high energy electrons, therefore excited gas molecule, ions and electrons are formed. The high energy excited gas molecule, ions and electrons are the so-called plasma. Thereafter, the excited atoms in the plasma will emit ultraviolet (UV) light to release the excitation energy, and the emitted UV light will excite the fluorescent substance in the cold cathode fluorescent flat lamp (CCFFL) to emit visible light.

FIG. 1 is a cross-sectional view schematically illustrating a conventional cold cathode fluorescent flat lamp (CCFFL). Referring to FIG. 1, the conventional cold cathode fluorescent flat lamp (CCFFL) 100 includes a first substrate 110, a second substrate 120, a frame 130, at least an electrode set 140 (three sets are shown in FIG. 1), a fluorescent substance 150 and a discharge gas 160. The frame 130 is disposed between the first substrate 110 and the second substrate 120 and connected to the edge of the first substrate 110 and the second substrate 120, thus a sealed cavity 170 is formed.

The electrode set 140 includes an anode 140a and a cathode 140b, wherein the anode 140a and the cathode 140b are disposed on the first substrate 110 and mutually parallel. The electrode set 140 is generally covered by a dielectric layer 180 to protect the electrode set 140 from the damage of the impact of ions. Alternatively, the electrode set 140 may be disposed on the surface of the first substrate 110 apart from the sealed cavity 170 to form the external electrode. In addition, the sealed cavity 170 is filled with the discharge gas 160. The discharge gas 160 generally includes xenon (Xe), neon (Ne), argon (Ar) or other inert gas. Moreover, the fluorescent substance 150 is disposed on the inner wall of the sealed cavity 170, such as the surface of the second substrate 120 and the surface of the dielectric layer 180.

It is noted that, the air pressure inside the sealed cavity 170 is much less than the air pressure outside. When a large area light source is necessary, since the gap between the first substrate 110 and the second substrate 120 is only supported by the frame 130, the central area of the cold cathode fluorescent flat lamp (CCFFL) 100 has a weaker structure strength and may be easily damaged by the force due to the pressure difference. Therefore, the thickness of the first substrate 110 and the thickness of the second substrate 120 is increased generally. Therefore, the whole thickness of the backlight module is increased since the thickness of the cold cathode fluorescent flat lamp (CCFFL) 100 is increased.

Accordingly, in order to solve the problem described above, the conventional cold cathode fluorescent flat lamp (CCFFL) 100 further includes a plurality of spacers 190 disposed between the first substrate 110 and the second substrate 120. Therefore, the structure strength of the central region is enhanced without increasing the thickness of substrate 110 or the substrate 120, and thus the cold cathode fluorescent flat lamp (CCFFL) 100 may not be damaged by the air pressure or other unexpected force. However, in order to fit all the spacers 190 with the first substrate 110 and the second substrate 120, the tolerance of the height of the spacers 190 is limited in 0.01 mm or less, wherein the tolerance of the height is defined as the maximum difference between the longest height and the shortest height. Therefore, the cost of the spacers 190 is increased in multiple along with the tolerance, and thus the process time is increased.

### SUMMARY OF INVENTION

Therefore, the present invention provides a cold cathode fluorescent flat lamp for reducing the cost and the process time of the cold cathode fluorescent flat lamp (CCFFL).

In addition, the present invention provides a cavity structure for reducing the cost and the process time of the cold cathode fluorescent flat lamp (CCFFL).

The present invention provides a cold cathode fluorescent flat lamp (CCFFL). The cold cathode fluorescent flat lamp (CCFFL) comprises, for example but not limited to, a cavity structure, at least an electrode set, a fluorescent substance and a discharge gas. The cavity structure comprises, for example but not limited to, a cavity shell, a plurality of spacers and a hardening paste. The spacer is disposed in the cavity shell. The tolerance of the height of the spacers is larger than about 0.01 mm, or in a range of about 1/20 to about 1/4 of the height of the spacer, wherein the tolerance is defined as the difference between the maximum height and the minimum height of the spacer. The hardening paste is disposed between the cavity shell and the spacer. The electrode set is disposed in the cavity shell. The fluorescent substance disposed on the inner wall of the cavity shell. The discharge gas is filled in the cavity shell.

In one embodiment of the invention, the height of the spacer is, for example but not limited to, in a range of about 1 mm to about 2 mm. The thickness of the hardening paste is, for example but not limited to, in a range of about 0.1 mm to about 0.25 mm. The thickness of the hardening paste is, for example but not limited to, in a range of about 1/20 to about 1/4 of the height of the spacer. The hardening paste comprises, for example but not limited to, glass paste.

In one embodiment of the invention, the cavity shell comprises, for example but not limited to, a first substrate, a second substrate and a frame. The second substrate is disposed over the first substrate. The frame is disposed, for example but not limited to, between the first substrate and the second substrate and connected to the edge of thereof. The air pressure inside the cavity shell is, for example but not limited to, less than the air pressure outside the cavity shell.

In addition, the present invention provides a cavity structure. The cavity structure comprises, for example but not limited to, a cavity shell, a plurality of spacers and a hardening paste. The spacers are disposed in the cavity shell. The tolerance of the height of the spacers is larger than 0.01 mm, or in a range of about 1/20 to about 1/4 of the height of the spacers. The hardening paste is disposed between the spacer and the cavity shell.

In one embodiment of the invention, the height of the spacer is, for example but not limited to, in a range of about 1 mm to about 2 mm. The thickness of the hardening paste is, for example but not limited to, in a range of about 0.1 mm to about 0.25 mm. The thickness of the hardening paste is, for example but not limited to, in a range of about 1/20 to about ¼ of the height of the spacers. The hardening paste comprises, for example but not limited to, glass paste.

In one embodiment of the invention, the air pressure inside the cavity shell is, for example but not limited to, less than the air pressure outside the cavity shell.

Accordingly, in the cavity structure and the cold cathode fluorescent flat lamp (CCFFL) using the same of the present invention, the tolerance of the height of the spacers may be larger than about 0.1 mm. Therefore, the cost, the process time and the complexity of manufacturing the spacer is reduced.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a cross-sectional view schematically illustrating a conventional cold cathode fluorescent flat lamp (CCFFL).

FIG. 2 is a cross-sectional view schematically illustrating a cavity structure and a cold cathode fluorescent flat lamp (CCFFL) using the cavity structure according to one embodiment of the present invention.

FIG. 3A to FIG. 3C are drawings schematically illustrating the enlarged view of the region A of FIG. 2.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

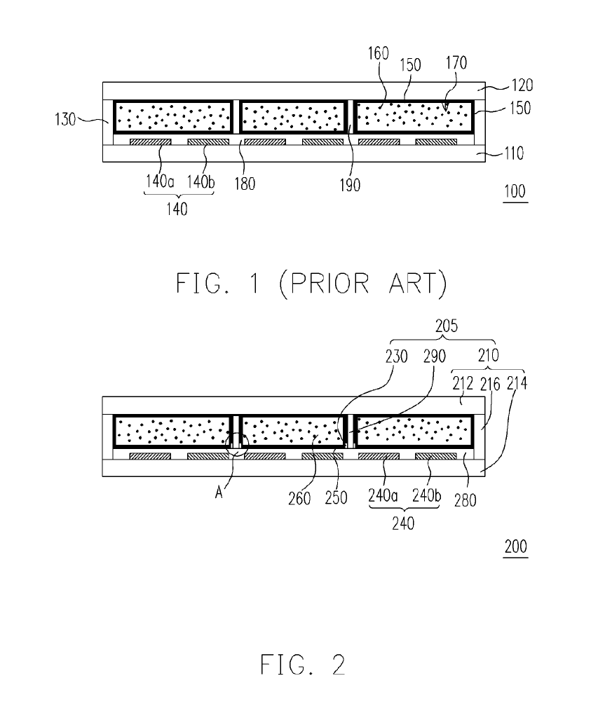

FIG. 2 is a cross-sectional view schematically illustrating a cavity structure and a cold cathode fluorescent flat lamp (CCFFL) using the cavity structure according to one embodiment of the present invention. Referring to FIG. 2, the cold cathode fluorescent flat lamp (CCFFL) 200 comprises, for example but not limited to, a cavity structure 205, at least one electrode sets 240 (three sets are shown in FIG. 2), a fluorescent substance 250 and a discharge gas 260. The cavity structure 205 comprises, for example but not limited to, a cavity shell 210, a plurality of spacers 290 and a hardening paste 230.

The spacers 290 are disposed inside the cavity shell 210 for supporting the cavity structure. The spacers 290 may be, for example but not limited to, rod shape. The tolerance of the height of the spacers 290 of the invention may be, for example but not limited to, larger than about 0.01 mm, or between about 1/20 to about ¼ of the height of the spacer 290. The tolerance of the height is defined as the maximum difference between the longest height and the shortest height of all of the spacers 290. The hardening paste 230 is disposed between the spacers 290 and the second substrate 214 or the dielectric layer 280, and is provided as an adhesive glue therein. In one embodiment of the present invention, the hardening paste 230 is disposed between the spacers 290 and the dielectric layer 280 (as the circled area A shown in FIG. 2). However, if the dielectric layer 280 is omitted (as described below), the hardening paste 230 may be disposed between the spacers 290 and the second substrate 214. In one embodiment of the present invention, the hardening paste 230 comprises, for example but not limited to, glass paste.

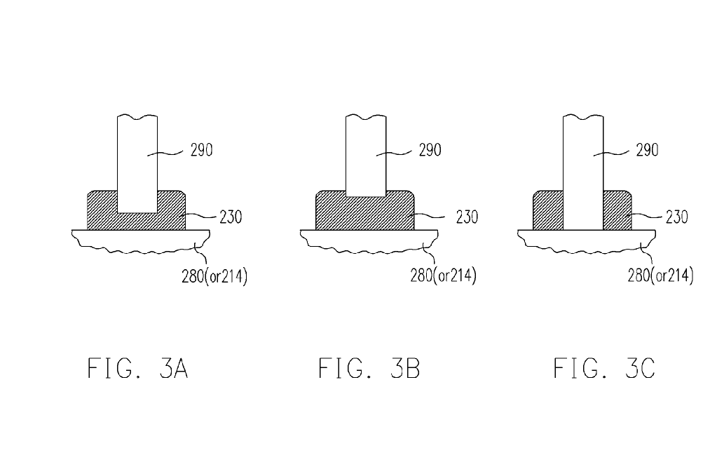

FIGS. 3A to 3C are enlarged drawings of the area A shown in FIG. 2. In one embodiment of the present invention, the height of the spacers 290 is, for example but not limited to, in a range of about 1 mm to about 2 mm, and the tolerance of the height is larger than 0.01 mm. Therefore, the cost and the difficulty of manufacturing the spacers 290 may be reduced in multiple in comparison with the conventional spacers having a tolerance of height less than 0.01 mm. Moreover, the thickness of the hardening paste 230 is, for example but not limited to, in a range of about 0.1 mm to about 0.25 mm. Alternatively, the thickness of the hardening paste 230 is, for example but not limited to, in a range of about 1/20 to about ¼ of the height of the spacer 290.

In one embodiment of the invention, the cavity shell 210 may be used in a cold cathode fluorescent flat lamp (CCFFL) 200. The cavity shell 210 comprises, for example but not limited to, a first substrate 212, a second substrate 214 and a frame 216. The manufacturing process of the cavity structure 205 and the cold cathode fluorescent flat lamp (CCFFL) 200 are described hereinafter. First, the hardening paste 230 is disposed over the second substrate 214. Then, the spacer 290 is disposed over the hardening paste 230. Thereafter, the hardening paste 230 and the spacer 290 above the second substrate 214 are heated for solidification. Then, the first substrate 212 is covered over the second substrate 214 to perform the thermal treatment for sealing. At this moment, since the hardening paste 230 is melted, every spacers 290 are glued with the hardening paste 230 in different dept has shown in FIG. 3A to FIG. 3C. After the hardening paste 230 is cooled and hardened, the total height of every spacers combined with the corresponding hardening pastes 230 are the same even though the height of every spacers 290 may be different. Thus, all the spacers 290 may be used for supporting the cavity structure 205.

Thereafter, referring to FIG. 2, the electrode set 240 is disposed on the cavity shell 210. In one embodiment of the invention, the electrode set is not limited to one set. The electrode set 240 may be, for example but not limited to, disposed inside the cavity shell 210 or outside the cavity shell 210. For example, if the electrode set 240 is disposed inside the cavity shell 210, the electrode set 240 may include, for example but not limited to, an anode 240a and a cathode 240b parallel to each other. In general, a dielectric layer 280 is covered over the electrode set 240 to protect the electrode set 240 from the damage of ion impact. If the electrode set 240 is disposed outside the cavity shell 210, the dielectric layer 280 is not necessary. The electrode set 240 may be comprised of, for example but not limited to, nickel (Ni), silver (Ag), copper (Cu), molybdenum (Mo) or niobium. The fluorescent substance 250 is disposed on the inner wall of the cavity shell 210. The discharge gas 260 is filled in the cavity shell 210. The discharge gas 260 is comprised of, for example but not limited to comprises, xenon (Xe), neon (Ne), argon (Ar) or other inert gas.

In addition, the first substrate 212 and the second substrate 214 may be comprised of, transparent substrate such as glass substrate. The frame 216 is, for example but not limited to, disposed between the first substrate 212 and the second substrate 214 and connected to the edge thereof. The air pressure in the cavity shell 210 may be, for example but not limited to, less than the air pressure outside the cavity shell 210.

It is noted that, the cavity structure of the invention is not only provided for the cold cathode fluorescent flat lamp (CCFFL), but also can be used in other products using spacer for enhancing the structure strength of the cavity structure. Especially, the invention is suitable for the cavity structure that the air pressure inside the cavity shell is less than that outside the cavity shell.

Accordingly, in the cavity structure and the cold cathode fluorescent flat lamp (CCFFL) using the same of the invention, a thick glass paste is disposed between the spacer and the cavity shell, and the spacer is disposed and fixed by melting the glass paste. Therefore, the tolerance of height of the spacer may larger than about 0.01 mm, and the different of height between every spacer is compensated by the glass paste. Therefore, since the tolerance of height of the spacer is increased, the cost, the process time and the complexity of manufacturing the spacer is reduced and the structure intensity of the spacer are increased.

It will be apparent to those skilled in the art that various modifications and variations can be made to the structure of the present invention without departing from the scope or spirit of the invention. In view of the foregoing, it is intended that the present invention cover modifications and variations of this invention provided they fail within the scope of the following claims and their equivalents.

1. A cold cathode fluorescent flat lamp, comprising:
a cavity structure, comprising:
a cavity shell;
a plurality of spacers, disposed in the cavity shell, wherein a tolerance of a height of the spacers is larger than about 0.01 mm, or the tolerance of the height of the spacers is in a range of about 1/20 to about ¼ of the height of the spacers;
a hardening paste, disposed between the cavity shell and the spacers;
at least an electrode set, disposed on the cavity shell;
a fluorescent substance, disposed on a inner wall of the cavity shell; and
a discharge gas, disposed in the cavity shell.

2. The cold cathode fluorescent flat lamp of claim 1, wherein the height of the spacer is in a range of about 1 mm to about 2 mm.

3. The cold cathode fluorescent flat lamp of claim 1, wherein the thickness of the hardening paste is in a range of about 0.1 mm to about 0.25 mm.

4. The cold cathode fluorescent flat lamp of claim 1, wherein a thickness of the hardening paste is in a range of about 1/20 to about ¼ of the height of the spacers.

5. The old cathode fluorescent flat lamp of claim 1, wherein the hardening paste comprises glass paste.

6. The cold cathode fluorescent flat lamp of claim 1, wherein the cavity shell comprising:
a first substrate;
a second substrate, disposed over the first substrate; and
a frame, disposed between the first substrate and the second substrate and connected to an edge of the first substrate and an edge of the second substrate.

7. The cold cathode fluorescent flat lamp of claim 1, wherein an air pressure inside the cavity shell is less than an air pressure outside the cavity shell.

8. A cavity structure, comprising:
a cavity shell;
a plurality of spacers, disposed in the cavity shell, wherein a tolerance of a height of the spacers is larger than about 0.01 mm, or the tolerance of the height of the spacers is in a range of about 1/20 to about ¼ of the height of the spacers; and
a hardening paste, disposed between the cavity shell and the spacer.

9. The cavity structure of claim 8, wherein the height of the spacer is in a range of about 1 mm to about 2 mm.

10. The cavity structure of claim 8, wherein a thickness of the hardening paste is in a range of about 0.1 mm to about 0.25 mm.

11. The cavity structure of claim 8, wherein a thickness of the hardening paste is in a range of about 1/20 to about ¼ of the height of the spacers.

12. The cavity structure of claim 8, wherein the hardening paste comprises glass paste.

13. The cavity structure of claim 8, where in an air pressure inside the cavity shell is less than an air pressure outside the cavity shell.
